(19) United States
(12) Patent Application Publication
(10) Pub. No.: US 2026/0189352 A1
(43) Pub. Date: Jul. 2, 2026

(54) METHOD AND DEVICE FOR CONFIGURING A DEMODULATION REFERENCE SIGNAL

(71) Applicant: Huawei Technologies Co., Ltd., Shenzhen (CN)

(72) Inventors: Monirosharieh Vameghestahbanati, Ottawa (CA); Huang Huang, Shenzhen (CN); Shahram Shahsavari, Ottawa (CA); Alireza Bayesteh, Brossard (CA)

(21) Appl. No.: 19/547,248

(22) Filed: Feb. 23, 2026

Related U.S. Application Data
(63) Continuation of application No. PCT/CN2023/114690, filed on Aug. 24, 2023.

(51) Int. Cl. H04L 5/00; H04L 1/00; H04L 27/26

(52) U.S. Cl. CPC H04L 5/0098; H04L 1/0061; H04L 5/0044; H04L 27/261

(57) ABSTRACT

Embodiments of this application provide a method and device for configuring a DMRS. The method includes: a transmission/reception point determines first sequence length information, where the first sequence length information is used to indicate a length of a first sequence used to generate a first DMRS; the transmission/reception point transmits the first sequence length information. The method may be applied to integrated sensing and communications system. According to this application, the ISAC system could perform both sensing and communication by using the a same DMRS sequence without introducing interference to other UEs.

### CROSS-REFERENCE TO RELATED APPLICATION

This application is a continuation of International Patent Application PCT/CN2023/114690, filed on Aug. 24, 2023, the entire contents of which is hereby incorporated by reference.

### TECHNICAL FIELD

Embodiments of the present application relate to the field of communication and sensing, and more specifically, to a method and device for configuring a demodulation reference signal (DMRS).

### BACKGROUND

The sixth generation (6G) of cellular systems is envisioned to transform connected people and connected things. This can be achieved by supporting a massive number of intelligent devices which have the capability of sensing their surroundings and communicating their observations. Intelligent devices, such as those in an integrated sensing and communications (ISAC) system, may be key components in 6G systems.

It is important to satisfy requirements of both sensing and communications in ISAC systems. For instance, a low error rate and a low peak-to-power-ratio (PAPR) are required for communications, while a low range root-mean-square (RMSE) and a low Doppler RMSE are required for sensing.

One element of ISAC systems that plays a role in fulfilling both sensing and communications requirements is the sequence design of reference signals (RS) such as DMRS.

### SUMMARY

Embodiments of the present application provide a method and related devices for configuring DMRS, which allows the ISAC system to perform both sensing and communication by using the a same DMRS sequence without introducing interference to other user equipment (UE).

According to a first aspect, this application provides a method for configuring DMRS. The method could be executed on transmission/reception point (TRP) side and includes:

determining first sequence length information, where the first sequence length information is used to indicate a length of a first sequence used to generate a first DMRS; and transmitting the first sequence length information.

For example, a first UE could receive the first sequence length information, and the first sequence length information can be used to generate the first DMRS. The first UE could be an arbitrary ISAC UE. The first sequence can be any constant envelope sequence, such as ZC sequence, the gold sequence, etc.

In one embodiment, the first sequence length information is determined based on a first frequency band, where the first frequency band is a frequency band of a second DMRS. The second DMRS is configured for a second UE. The second UE could be an arbitrary UE and different from the first UE. For example, when a bandwidth (BW) of the first DMRS overlaps with a BW of the second DMRS and the frequency band of the second DMRS is within the frequency band of the first DMRS, the first sequence length information could be determined based on the first frequency band.

In another embodiment, the first sequence length information could be determined based on the BW of the first DMRS. For example, when the BW of the first DMRS does not overlap with that of other DMRS, the first sequence length information could be determined based on the BW of the first DMRS.

According to the above-mentioned technical solution, the first sequence with flexible length can be adopted. The ISAC system could perform both sensing and communication without introducing interference to other UEs, by using the a same DMRS sequence which is based on the first sequence.

In possible implementations, the first DMRS in the first frequency band could be generated according to the first sequence.

In possible implementations, the frequency band of the first DMRS could further include a second frequency band, where the second frequency band is occupied by the first DMRS only. The first DMRS in the second frequency band could be generated based on the first sequence.

For example, when the frequency band of the second DMRS is within the frequency band of the first DMRS and the BW of the second DMRS is less than the BW of the first DMRS, there could be a frequency band occupied by the first DMRS only.

In another example, the first DMRS in the first frequency band and the second frequency band could be generated by an extension version of the first sequence.

In possible implementations, the method could further include: determining first cyclic shift information, where the first cyclic shift information is used to indicate a cyclic shift of the first sequence relative to a second sequence, and the second sequence is used to generate the second DMRS; and transmitting the first cyclic shift information.

According to the above-mentioned technical solution, since the first cyclic shift information indicate a cyclic shift of the first sequence, the first sequence could be orthogonal to the second sequence. The ISAC system could perform both sensing and communication by using the first DMRS without introducing interference to the second UE.

In possible implementations, the first DMRS corresponds to a first physical uplink shared channel (PUSCH), and the second DMRS corresponds to a second PUSCH. Determining the first cyclic shift information includes: determining the first cyclic shift information based on a BW of the first PUSCH or a BW of the second PUSCH.

In possible implementations, the frequency band of the first DMRS further includes a third frequency band, where the third frequency band is a frequency band of a third DMRS. The method further includes: determining second sequence length information based on a BW of the third frequency band, and transmitting the second sequence length information. The second sequence length information is used to indicate a length of a third sequence, and the third sequence is used to generate the first DMRS in the third frequency band.

For example, the third DMRS is configured for a third UE which is an arbitrary ISAC UE and different from the first UE and the second UE. The frequency band of the third DMRS is the third frequency band.

In another example, when the BW of the third DMRS is overlapping with the BW of the first DMRS and the frequency band of the third DMRS is within the frequency band of the first DMRS, the second sequence length information could be determined based on the third frequency band.

In possible implementations, the method could further include: determining second cyclic shift information and transmitting the second cyclic shift information, where the second cyclic shift information is used to indicate a cyclic shift of the third sequence relative to a fourth sequence, and the fourth sequence is used to generate the third DMRS.

According to the above-mentioned technical solution, since the third sequence could be a cyclic version of the fourth sequence, the third sequence could be orthogonal to the fourth sequence. The ISAC system could perform both sensing and communication by using the first DMRS without introducing interference to the third UE.

In possible implementations, the first sequence length information could include an indication parameter. The first indication parameter with the BW of the first DMRS could be used to determine the length of the first sequence.

In one embodiment, when the indication parameter takes a first value, the length of the first sequence can be determined based on the BW of the first DMRS.

In another embodiment, when the indication parameter takes a second value, the length of the first sequence can be determined according to a difference of the BW of the first DMRS and the BW of the first PUSCH.

In another embodiment, when the BW of the first DMRS is equal to the BW of the first PUSCH, the length of the first sequence can be determined based on the BW of the first DMRS.

According to the above-mentioned technical solution, it can reduce the configuration overhead by using the indication parameter to indicate the length of the first sequence.

In possible implementations, the method could further include: determining expansion information, and transmitting the expansion information, where the expansion information is used to indicate an expansion of the frequency band of the first DMRS relative to the frequency band of a first PUSCH.

According to the above-mentioned technical solution, it can reduce the configuration overhead by using the expansion information.

In possible implementations, the method could further include: determining frequency hopping information, and transmitting the frequency hopping information, where the frequency hopping information indicates a frequency hopping manner of the frequency band of the first PUSCH within the frequency band of the first DMRS.

According to the above-mentioned technical solution, using the frequency hopping can improve the communication performance.

In possible implementations, the method could further include: obtaining first indication information, and determining that the first UE is an ISAC device based on the first indication information, where the first indication information indicates a communication mode of first UE. The communication mode includes a communication-only device or an ISAC device.

In possible implementations, the first sequence length information is carried on a radio resource control (RRC) channel or a downlink control information (DCI) channel.

According to a second aspect, this application provides a method for configuring DMRS. The method could be executed on UE side and includes:

receiving first sequence length information, and determining the first DMRS based on at least one of the first sequence length information, a BW of the first DMRS, and a BW of a first PUSCH, where the first DMRS corresponds to the first PUSCH, the first sequence length information is used to indicate a length of a first sequence, and the first sequence is used to generate a first DMRS.

In possible implementations, the first sequence length information could include an indication parameter. Determining the first DMRS based on at least one of the first sequence length information, a BW of the first DMRS, and a BW of a first PUSCH, could include: determining the length of the first sequence based on the BW of the first DMRS, when the indication parameter takes a first value or when the BW of the first DMRS is equal to the BW of the first PUSCH; or determining the length of the first sequence based on a difference of the BW of the first DMRS and the BW of the first PUSCH; and determining the first sequence and the first DMRS based on the length of the first sequence.

In possible implementations, determining the first DMRS based on at least one of the first sequence length information, a BW of the first DMRS, and a BW of a first PUSCH, includes: determining the first sequence based on the first sequence length information, and generating the first DMRS based on the first sequence.

In possible implementations, the frequency band of the first DMRS includes a first frequency band, where the first frequency band is a frequency band of a second DMRS, and the first sequence length information is determined based on the first frequency band. Generating the first DMRS based on the first sequence, could include: generating the first DMRS in the first frequency band based on the first sequence.

In possible implementations, the frequency band of the first DMRS could further include a second frequency band, and the second frequency band is occupied by the first DMRS only. Generating the first DMRS based on the first sequence, could include: generating the first DMRS based on the first sequence in the second frequency band.

In possible implementations, the method could further include: receiving first cyclic shift information, where the first cyclic shift information is used to indicate a cyclic shift of the first sequence. Determining the first sequence based on the first sequence length information, includes: determining the first sequence based on the first sequence length information and the first cyclic shift information.

In possible implementations, the frequency band of the first DMRS could further include a third frequency band, where the third frequency band is a frequency band of a third DMRS. The method could further include: receiving second sequence length information, and determining the third sequence based on the second sequence length information, where the second sequence length information is used to indicate a length of a third sequence, and the third sequence is used to generate the first DMRS in the third frequency band.

In possible implementations, the method could further include: receiving second cyclic shift information, where the second cyclic shift information is used to indicate a cyclic shift of the third sequence. Determining the third sequence based on the second sequence length information, could include: determining the third sequence based on the second sequence length information and the second cyclic shift information.

In possible implementations, the method could further include: receiving expansion information, and determining the BW of the PUSCH based on the expansion information, where the expansion information is used to indicate an expansion of the frequency band of the first DMRS relative to a frequency band of the first PUSCH.

In possible implementations, the method could further include: receiving frequency hopping information, and determining the first PUSCH based on the frequency hopping information, where the frequency hopping information indicates a frequency hopping manner of the frequency band of the first PUSCH within the frequency band of the first DMRS.

In possible implementations, the method could further include: transmitting first indication information, where the first indication information indicates a communication mode of UE, where the communication mode includes a communication-only device or an ISAC device.

In possible implementations, the first sequence length information is carried on an RRC channel or DCI channel.

For the beneficial effects of the second aspect, reference is made to the first aspect. Details are not described herein again.

According to a third aspect, this application provides an apparatus for configuring DMRS. The apparatus includes: a first determination unit, configured to determine first sequence length information, where the first sequence length information is used to indicate a length of a first sequence used to generate a first DMRS; a transmitting unit, configured to transmit the first sequence length information.

For example, the first determination unit could determine first sequence length information based on a BW of a first frequency band, which is different from the frequency band of the first DMRS. The first frequency band could be a frequency band of a second DMRS.

In another example, the first determination unit could determine first sequence length information, based on the BW of the first DMRS.

In possible implementations, the first DMRS in the first frequency band is generated according to the first sequence.

In possible implementations, the frequency band of the first DMRS could further include a second frequency band, where the second frequency band is occupied by the first DMRS only, and the first DMRS in the second frequency band is generated according to the first sequence.

In possible implementations, the first determining unit could be further configured to determine first cyclic shift information, where the first cyclic shift information is used to indicate a cyclic shift of the first sequence relative to a second sequence, and the second sequence is used to generate the second DMRS. And the transmitting unit is further configured to transmit the first cyclic shift information.

In possible implementations, the first determining unit could be configured to determine the first cyclic shift information based on a BW of a first PUSCH or a BW of a second PUSCH, where the first DMRS corresponds to the first PUSCH, and the second DMRS corresponds to the second PUSCH.

In possible implementations, the frequency band of the first DMRS further includes a third frequency band, and the third frequency band is a frequency band of a third DMRS. The first determining unit could be configured to determine second sequence length information, based on a BW of the third frequency band, where the second sequence length information is used to indicate a length of a third sequence and the third sequence is used to generate the first DMRS in the third frequency band. The transmitting unit is further configured to transmit the second sequence length information.

In possible implementations, the first determining unit could be configured to determine second cyclic shift information, where the second cyclic shift information is used to indicate a cyclic shift of the third sequence relative to a fourth sequence, and the fourth sequence is used to generate the third DMRS. The transmitting unit is further configured to transmit the second cyclic shift information.

In possible implementations, the first sequence length information could include an indication parameter. The first indication parameter with the BW of the first DMRS could be used to determine the length of the first sequence.

In one embodiment, when the indication parameter takes a first value or when the BW of the first DMRS is equal to the BW of the first PUSCH, the length of the first sequence can be determined based on the BW of the first DMRS.

In another embodiment, when the indication parameter takes a second value, the length of the first sequence can be determined according to a difference of the BW of the first DMRS and the BW of the first PUSCH.

In possible implementations, the first determining unit could be configured to determine expansion information, where the expansion information is used to indicate an expansion of the frequency band of the first DMRS relative to the frequency band of a first PUSCH. The transmitting unit is further configured to transmit the expansion information.

In possible implementations, the first determining unit could be configured to determine frequency hopping information, where the frequency hopping information indicates a frequency hopping manner of the frequency band of the first PUSCH within the frequency band of the first DMRS. The transmitting unit is further configured to transmit the frequency hopping information.

In possible implementations, the first determining unit could be configured to obtain first indication information, and determining that the first UE is an ISAC device based on the first indication information, where the first indication information indicates a communication mode of the first UE, and the communication mode includes a communication-only device or an ISAC device.

In possible implementations, the first sequence length information is carried on an RRC channel or a DCI channel.

According to a fourth aspect, this application provides an apparatus for configuring DMRS. This apparatus includes: a receiving unit, configured to receive the first sequence length information, where the first sequence length information is used to indicate a length of a first sequence, and the first sequence is used to generate a first DMRS; and a second determining unit, configured to determine the first DMRS based on at least one of the first sequence length information, a BW of the first DMRS, and a BW of a first PUSCH, where the first DMRS corresponds to the first PUSCH.

In possible implementations, the first sequence length information could include an indication parameter. The second determining unit could be configured to: determine the length of the first sequence based on the BW of the first DMRS, when the indication parameter takes a first value or when the BW of the first DMRS is equal to the BW of the first PUSCH; or determine the length of the first sequence based on a difference of the BW of the first DMRS and the BW of a first PUSCH; and determine the first sequence and the first DMRS based on the length of the first sequence.

In possible implementations, the second determining unit could be configured to: determine the first sequence based on the first sequence length information, and determine the first DMRS based on the first sequence.

In possible implementations, the frequency band of the first DMRS includes a first frequency band, where the first frequency band is a frequency band of a second DMRS, and the first sequence length information is determined based on the first frequency band. The second determining unit could be configured to determine the first DMRS in the first frequency band based on the first sequence.

In possible implementations, the frequency band of the first DMRS further includes a second frequency band, and the second frequency band is occupied by the first DMRS only. The second determining unit could be configured to determine the first DMRS in the second frequency band based on the first sequence.

In possible implementations, the receiving unit could further be configured to receive first cyclic shift information, where the first cyclic shift information is used to indicate a cyclic shift of the first sequence. The second determining unit could be configured to determine the first sequence based on the first sequence length information and the first cyclic shift information.

In possible implementations, the frequency band of the first DMRS could further include a third frequency band, where the third frequency band is a frequency band of a third DMRS. The receiving unit could further be configured to receive second sequence length information, where the second sequence length information is used to indicate a length of a third sequence. The second determining unit could be configured to: determine the third sequence based on the second sequence length information, and determine the first DMRS in the third frequency band based on the third sequence.

In possible implementations, the receiving unit could further be configured to receive second cyclic shift information, where the second cyclic shift information is used to indicate a cyclic shift of the third sequence. The second determining unit could be configured to determine the third sequence based on the second sequence length information and the second cyclic shift information.

In possible implementations, the receiving unit could further be configured to receive expansion information, where the expansion information is used to indicate an expansion of the frequency band of the first DMRS relative to a frequency band of a first PUSCH. The second determining unit could be configured to determine the BW of the PUSCH based on the expansion information.

In possible implementations, the receiving unit could further be configured to receive frequency hopping information, where the frequency hopping information indicates a frequency hopping manner of the frequency band of the first PUSCH within the frequency band of the first DMRS. The second determining unit could be configured to determine the first PUSCH based on the frequency hopping information.

In possible implementations, the apparatus further includes a transmitting unit, configured to transmit first indication information, where the first indication information indicates a communication mode of UE, and the communication mode includes a communication-only device or an ISAC device.

In possible implementations, the first sequence length information is carried on an RRC channel or DCI channel.

According to a fifth aspect, an apparatus including a processor and a memory is provided. The processor is connected to the memory. The memory is configured to store instructions, and the processor is configured to execute the instructions. When the processor executes the instructions stored in the memory, the processor is enabled to perform the method in any possible implementation of the first aspect or the second aspect.

According to a sixth aspect, this application provides a communication system, which includes an apparatus in any possible implementation of the third aspect and the fourth aspect, as well as an apparatus in any possible implementation of the fifth aspect.

According to a seventh aspect, this application provides a computer readable storage medium, which includes instructions. When the instructions run on a processor, the processor is enabled to perform the method in any possible implementation of the first aspect or the second aspect.

According to an eighth aspect, this application provides a computer program product, which includes computer program code. When the computer program code runs on a computer, the computer is enabled to perform the method in any possible implementation of the first aspect or the second aspect.

In possible implementations, all or a part of the above computer program code can be stored in on a first storage medium. The first storage medium can be packaged together with the processor or separately with the processor.

According to a ninth aspect, this application provides a chip system, which includes a memory and a processor. The memory is configured to store a computer program, and the processor is configured to invoke the computer program from the memory and run the computer program, so that an electronic device on which the chip system is disposed performs the method in any possible implementation of the first aspect or the second aspect.

### DESCRIPTION OF THE DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limited to scale, in which:

FIG. 1 is a schematic diagram of a time-frequency relationship of a chirp.

FIG. 2 is a schematic diagram of a time-frequency relationship between DMRS and data.

FIG. 3 is another schematic diagram of a time-frequency relationship between DMRS and data.

FIG. 4 is a schematic diagram of a time-frequency relationship of a UE with intention of extending its DMSR BW.

FIG. 5 is a schematic diagram of a method for configuring DMRS of present application.

FIG. 6 is a schematic diagram of a scenario with PUSCH BW in the middle of a DMRS BW.

FIG. 7 is a schematic diagram of a scenario with PUSCH BW at the bottom of a DMRS BW.

FIG. 8 is a schematic diagram of a scenario with PUSCH BW on the top of a DMRS BW.

FIG. 9 is a schematic diagram of a time-frequency relationship in case 1.

FIG. 10 is a schematic diagram of a time-frequency relationship in a deformation of case 1.

FIG. 11 is a schematic diagram of a time-frequency relationship in another deformation of case 1.

FIG. 12 is a schematic diagram of a time-frequency relationship in case 2.

FIG. 13 is a schematic diagram of a time-frequency relationship in case 3.

FIG. 14 is a schematic diagram of an example of extending a DMRS BW of one UE to multiple sub-bands.

FIG. 15 is a schematic diagram of a deformation of FIG. 14.

FIG. 16 is a schematic diagram of a method for configuring DMRS of the present application.

FIG. 17 is a schematic diagram of a signaling diagram of the present application.

FIG. 18 is a schematic block diagram of an apparatus for configuring DMRS according to an embodiment of the present application.

FIG. 19 is a schematic block diagram of another apparatus for configuring DMRS according to an embodiment of the present application.

FIG. 20 is a schematic block diagram of another apparatus for configuring DMRS according to an embodiment of the present application.

### DETAILED DESCRIPTION OF THE ILLUSTRATIVE EMBODIMENTS

In order to understand features and technical contents of embodiments of the present disclosure in detail, implementations of the embodiments of the present disclosure will be described in detail below with reference to the accompanying drawings, and the attached drawings are only for reference and illustration purposes, and are not intended to limit the embodiments of the present disclosure. In the following technical descriptions, for ease of explanation, numerous details are set forth to provide a thorough understanding of the disclosed embodiments. One or more embodiments, however, may be practiced without these details. In other cases, well-known structures and apparatuses may be shown simplified in order to simplify the drawings.

Related technologies and concepts are introduced here firstly in order to better understand the technical solution proposed by the present application.

A chirp signal is a frequency-modulated signal of a known stable frequency whose instantaneous frequency varies linearly over a fixed period of time by a modulating signal. Specifically, an up-chirp means that the instantaneous frequency rises with time, and a down-chirp means that the instantaneous frequency decreases with time.

Let Tₛ be the symbol duration, B be the bandwidth, f₀ be the carrier frequency, and θ₀ be the initial phase. A frequency-modulated continuous wave (FMCW) can be expressed as x(t)=e^{-j(παt}^{²}^{+2πf}^{₀}^{t+θ}^{₀}⁾, where α=B/Tₛ represents the chirp rate and t∈[0, Tₛ]. The frequency of each chirp can be expressed as

$$f ( t ) = \frac{1}{2 π} \frac{d φ ( t )}{dt} = - ( α t + {f}_{0} ) ,$$

where φ(t) represents the phase of x(t). It is shown that the frequency of a chirp is a linear function of its time. FIG. 1 shows a time-frequency relationship of a chirp. Taking the down-chirp as an example, as shown in FIG. 1, during the symbol duration, the frequency of the chirp changes from f₀ to f₀−B with the chirp rate −α.

A Zadoff-Chu (ZC) sequence is a sampled version of a chirp signal, which may be a possible candidate for sensing. Moreover, the ZC sequence is widely used in long term evolution (LTE) and new radio (NR) as a reference signal (RS) due to its excellent properties. As such, the ZC sequence may be the basis of a candidate sequence for ISAC.

A cyclic shift (CS) in the time domain, also known as a circular shift, is simply the rotation of a finite length sequence. The mth cyclic shift of a given sequence x[n] of length N can be expressed as xₘ[n]=x[(n+m) mod N], where mod denotes the modulo operation which is a function used to obtain the remainder of the division.

To create a cyclically extended ZC sequence with an arbitrary length K, we compute y[k]=x[k mod N], k=0, . . . , K−1, N<K. In other words, when doing a cyclic extension, the necessary number of values of the sequence x[n] could be moved to the end of that sequence in order to create the desired length.

In LTE and NR, for example, a ZC sequence with good auto-correlation characteristics and good cross-correlation characteristics is used for a DMRS sequence. As a result, the DMRS may have low PAPR characteristics.

For example, a sequence r(n) of the DMRS can be represented by the following expression.

$$r ( n ) = {e}^{jan} {x}_{q} ( n mod {N}_{zc} ) ,$$

$$n = 0 , 1 , … , {M}_{SC}^{PUSCH} / {2}^{δ} - 1$$

Here,

$${x}_{q} ( m ) = {e}^{- j \frac{π qm ( m + 1 )}{{N}_{zc}}}$$

represents the ZC sequence with a root index

$$⌊ \overline{q} + 1 / 2 ⌋ + ν \cdot {( - 1 )}^{⌊ 2 \overline{q} ⌋} , \overline{q} = {N}_{zc} \cdot ( u + 1 ) / 31. {M}_{SC}^{PUSCH}$$

denotes the scheduled data BW for the uplink transmission, i.e., PUSCH. N_{zc} denotes a length of the ZC sequence, and is the largest prime number such that

$${N}_{zc} < {M}_{SC}^{PUSCH} / {2}^{δ} - 1.$$

a denotes the cyclic shift, δ=1, v∈{0,1}, and u∈{0, 1, . . . , 29}.

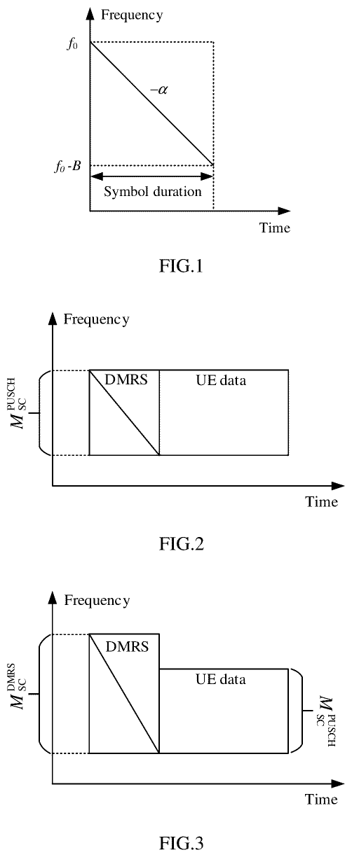

From this expression, the DMRS sequence is generated based on the scheduled data BW for the uplink transmission. In other words, the DMRS BW is the same as PUSCH BW. FIG. 2 illustrates the time-frequency relationship between DMRS and data. As shown in FIG. 2, the DMRS is represented by a small rectangle, with the ZC sequence represented by a linear function with its frequency changing linearly with time, and UE's data is represented by a large rectangle. As shown in FIG. 2, both DMRS and data share the same BW (equal to

$${M}_{SC}^{PUSCH} ) ,$$

but are transmitted over different time slots.

In order to improve the channel estimation quality, a DMRS sequence r(n) is generated based on the DMRS BW instead of the scheduled data BW, and can be represented by the following expression.

$$r ( n ) = {e}^{jan} {x}_{q} ( n mod {N}_{zc} ) , n = 0 , 1 , ... , {M}_{SC}^{DMRS} / {2}^{δ} - 1$$

Here,

$${M}_{SC}^{DMRS}$$

denotes the scheduled DMRS BW for the uplink transmission, which is higher than the scheduled data BW, and N_{zc} is the largest prime number such that

$${N}_{zc} < {M}_{SC}^{DMRS} / {2}^{δ} - 1.$$

Accordingly, FIG. 3 shows a time-frequency relationship between DMRS and data. In FIG. 3, the DMRS is represented by a small rectangle, with the ZC sequence represented by a linear function with its frequency changing linearly with time, and UE data is represented by a large rectangle. As shown in FIG. 3, the DMRS BW is greater than the data BW, i.e.,

$${M}_{SC}^{DMRS} > {M}_{SC}^{PUSCH} .$$

As mentioned above, for ISAC systems, it is important to satisfy the requirements of sensing and communications systems. For instance, a low error rate and a low PAPR are required for communications, while a low RMSE and a low doppler RMSE are required for sensing. However, using the same DMRS symbol for sensing and communications will negatively impact both sensing and communications systems. For instance, using the same DMRS BW as the PUSCH BW, as shown in FIG. 2, can meet the requirements for communications, but more BWs are required to improve the sensing performance. On the other hand, when DMRS BW is greater than PUSCH BW as shown in FIG. 3, the orthogonality of DMRS of different UEs of neighboring bands may not be guaranteed. It is more pronounced if one UE intends to extend its DMRS BW but not the other UEs.

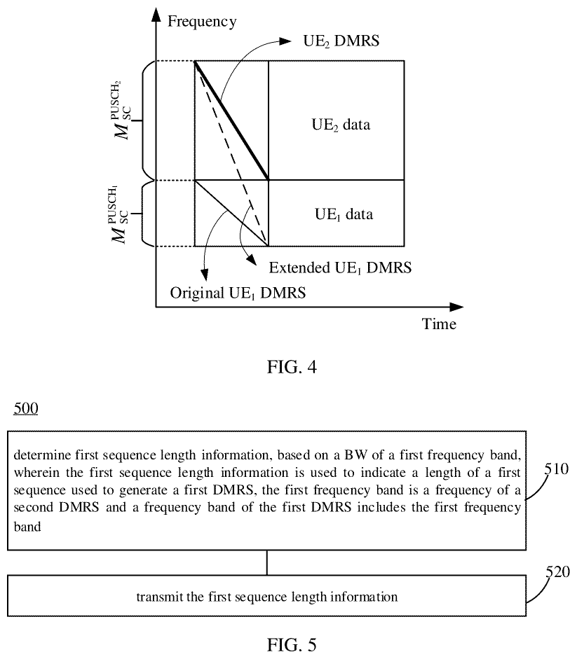

FIG. 4 shows a time-frequency relationship of UE with the intention of extending its DMSR BW. As shown in FIG. 4, the data of UE₁ and UE₂ are each represented as a rectangle, and the two rectangles are adjacent in the frequency direction. Let

$${M}_{SC}^{{PUSCH}_{1}} and {M}_{SC}^{{PUSCH}_{2}}$$

denote the PUSCH BW of UE₁ and UE₂, respectively.

It is assumed that UE₁ is an ISAC UE. When UE₁ is in communication mode, it can transmit over

$${M}_{SC}^{{PUSCH}_{1}}$$

with an NR-based DMRS sequence (as in FIG. 2). On the other hand, if UE₁ wants to use the same DMRS time slots for sensing, it may extend its DMRS BW according to its sensing key performance indicators (KPIs). For example, its DMRS BW may be extended from

$${M}_{SC}^{{PUSCH}_{1}}$$

to

$${M}_{SC}^{{PUSCH}_{1}} + {M}_{SC}^{{PUSCH}_{2}} .$$

However, as shown in FIG. 4, if

$${M}_{SC}^{{PUSCH}_{2}}$$

is already scheduled for UE₂ DMRS, UE₁ and UE₂ will interfere with each other when the existing ZC sequence lengths are used. This is due to the fact that the low cross-correlation property of two ZC sequences is only preserved if both sequences have the same length, i.e., generated over the same BW. Therefore, using the methods shown in FIG. 2 and FIG. 3 to obtain the UE₂'s DMRS and the extended UE₁'s DMRS respectively, will negatively impact both communications and sensing performance.

This application proposed a method for DMRS design. In this method, by ensuring DMRS orthogonality between different UEs even after employing a larger DMRS BW than the PUSCH BW, the same DMRS sequence for sensing and communication can be used without affecting the communication or sensing performance. Moreover, this application can be applied to multi-user scenarios.

The present application can be applicable to scenarios with integrated sensing and communications. It can be specified in the 3rd generation partnership project (3GPP) standard, i.e., RAN1 and RAN2, to enable the use of the same DMRS symbol employed for channel estimation purposes for sensing, as well, by DMRS BW extension, without introducing additional interference to other overlapping UEs and impacting communications or sensing performance.

The following describes the proposed solution of the present application in more detail.

FIG. 5 is a schematic diagram of a method 500 for configuring DMRS of the present application. As shown in FIG. 5, the method 500 specifically includes the following steps.

Step 510: a TRP determines first sequence length information, based on a BW of a first frequency band, where the first sequence length information is used to indicate a length of a first sequence used to generate a first DMRS, the first frequency band is a frequency band of a second DMRS, and a frequency band of the first DMRS includes the first frequency band.

For example, a TRP could configure DMRS for multiple UEs, including a first UE and a second UE, where the first DMRS is configured for the first UE and the second DMRS is configured for the second UE. The first UE can be an arbitrary ISAC UE, and it can use the first DMRS for both sensing and communication. In order to satisfy the requirements of sensing and communications, a BW of the first DMRS can be larger than a BW used for data transmission of the first UE. The second UE can be an arbitrary UE and different from the first UE.

In some possible implementations, resources of the first DMRS in time domain are the same as resources of the second DMRS in time domain. The frequency band of the first DMRS includes the first frequency band, and a frequency band of the second DMRS is within the frequency band of the first DMRS. In other words, the DMRS band of the first UE overlaps with that of the second UE.

In one embodiment, UE may transmit first indication information, and correspondingly, the TRP receives the first indication information. The first indication information is used to indicate a communication mode of UE. The UE can be recognized as an ISAC device or a communication-only device base on the first indication information.

For example, the first indication information includes a fallback mode parameter ζ. Based on the value of ζ, the mode of the UE can be determined.

In one embodiment, ζ could be a binary parameter. For example, if ζ=1, the UE is recognized as an ISAC UE, which uses the DMRS for both sensing and communications; or if ζ=0, the UE is recognized as a communications-only UE, which uses the DMRS just for communications purposes. In another example, when ζ=1, the UE could be recognized as a communications-only UE; or, when ζ=0, the UE could be recognized as an ISAC UE. In another example, if the TRP does not receive the first indication information or the UE does not send the first indication information, the UE could be recognized as a communication-only device.

In some possible implementations, ISAC UE can transmit second indication information which is used to indicate its sensing KPI. Correspondingly, the TRP obtains the second indication information. The BW and/or the frequency band of the first DMRS can be determined according to the sensing KPI.

In some possible implementations, using the first sequence to generate the first DMRS includes that the first DMRS is generated by the first sequence, or by an extension version of the first sequence, or by a cyclic shift version of the first sequence.

The first sequence can be any constant envelope sequence, such as ZC sequence, other constant amplitude zero auto-correlation (CAZAC) sequence, etc. The first DMRS and the second DMRS could be generated based on sequences of the same type. For example, if the first sequence is a ZC sequence, the sequence used to generate the second DMRS is a ZC sequence too. The following embodiments are illustrated assuming that the first sequence is a ZC sequence, which is also applicable when the first sequence is any other constant envelope sequence. For example, the first sequence could also be the gold sequence.

Step 520: the TRP transmits the first sequence length information.

Correspondingly, the first UE receives the first sequence length information. And the first UE can determine the first DMRS based on the first sequence length information. For example, the first UE can determine the first DMRS based on at least one of the first sequence length information, a BW of the first DMRS, and a BW of a first PUSCH.

In one embodiment, TRP can determine expansion information and transmit the expansion information. Correspondingly, the first UE could receive the expansion information. The expansion information is used to indicate an expansion of the frequency band of the first DMRS relative to a frequency band of a first PUSCH. The first DMRS corresponds to the first PUSCH. The first DMRS is configured for the first UE, and the first UE could use the first PUSCH for data transmission.

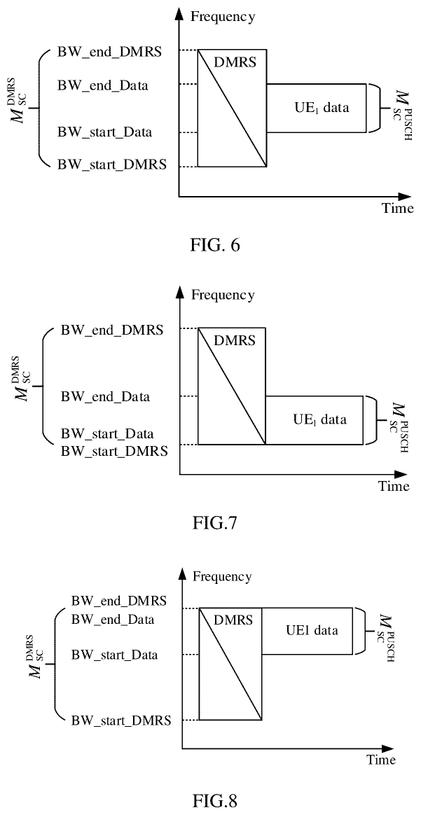

For illustrative purposes, the expansion information is described below in detail in conjunction with FIG. 6 to FIG. 8. As shown in FIG. 6 to FIG. 8, it is supposed that UE₁ is an ISAC UE, and UE₁ is taken as an example of the first UE.

Let BW_start_DMRS denote the starting frequency of DMRS BW, BW_end_DMRS denote the end frequency of DMRS BW, BW_start_Data denote the starting frequency of PUSCH, and BW_end_Data denote the end frequency of PUSCH BW. ρ is a factor, and 0<ρ<1, which could be taken as example of the expansion information mentioned. Moreover, RB represents the resource block.

In some possible implementations, the following can be done to reduce the configuration overhead.

In one embodiment, PUSCH BW is in the middle of the DMRS BW and DMRS extension BW is a factor of the PUSCH BW. For example, FIG. 6 is an illustration of a scenario with PUSCH BW in the middle of the DMRS BW. As shown in FIG. 6,

$$BW\_start \_DMRS = BW\_start \_Data - {⌊ ρ {M}_{SC}^{DMRS} ⌋}_{RB} ,$$

$$BW\_end \_DMRS = BW\_end \_Data + {⌊ ρ {M}_{SC}^{DMRS} ⌋}_{RB} .$$

In another embodiment, data BW is at the bottom of the DMRS BW and DMRS BW is a factor of the data BW. For example, FIG. 7 is an illustration of a scenario with PUSCH BW at the bottom of the DMRS BW. As shown in FIG. 7,

$$BW\_start \_DMRS = BW\_start \_Data ,$$

$$BW\_end \_DMRS = BW\_end \_Data + {⌊ ρ {M}_{SC}^{DMRS} ⌋}_{RB} .$$

In another embodiment, data BW is on the top of the DMRS BW and DMRS BW is a factor of the data BW. For example, FIG. 8 is an illustration of a scenario with PUSCH BW on the top of the DMRS BW. As shown in FIG. 8,

$$BW\_start \_DMRS = BW\_start \_Data - {⌊ ρ {M}_{SC}^{DMRS} ⌋}_{RB} ,$$

$$BW\_end \_DMRS = BW\_end \_Data .$$

In some possible implementations, the TRP can determine frequency hopping information, which indicates a frequency hopping manner of the frequency band used for the data transmission of the first UE within the frequency band of the first DMRS.

For example, the frequency hopping information may include a frequency hopping rate, a frequency hopping width, and so on.

Moreover, in order to improve the communication performance, data in one PUSCH or physical data shared channel (PDSCH) can use frequency hopping within the DMRS BW for different orthogonal frequency-division multiplexing (OFDM) symbol, e.g., hopping among the bottom/middle/top of the DMRS BW.

In some possible implementations, if the DMRS band of the first UE overlaps with that of other UE(s), a DMRS signal with flexible ZC sequence length can be adopted.

In one embodiment, the frequency band of the second DMRS is within the frequency band of the first DMRS. As mentioned above, the frequency band of the second DMRS is defined as the first frequency band. The frequency band of the first DMRS includes the first frequency band. The first sequence length information indicates a length of a first sequence, and the first DMRS in the first frequency band is generated based on the first sequence.

In possible implementations, the frequency band of the second DMRS is within the frequency band of the first DMRS, and the BW of the first DMRS is larger than that of the second DMRS. Thus, the frequency band of the first DMRS could further include a second frequency band, which is occupied by the first DMRS only. The first DMRS in the second frequency band is generated based on the first sequence too. For example, within the first frequency band and the second frequency band, the first DMRS could be generated by an extension version of the first sequence.

In a possible implementation, the first frequency band and the second frequency band are adjacent to each other. The second frequency band includes a frequency band for data transmission of the first UE.

For example, when the second UE is a communication-only device, the BW of the second DMRS could be less than the BW of the first DMRS, and thus there could be a frequency band occupied by the first DMRS only, i.e., the second frequency band even if the BW of second DMRS is within the BW of first DMRS. In this situation, the length of the first sequence can be determined according to a BW of the first frequency band. Within the first frequency band and the second frequency band, the first DMRS is generated by an extension version of the first sequence.

In another example, when the second UE is also an ISAC device, the second UE may extend its DMRS BW and the BW of the second DMRS could be the same as the BW of the first DMRS. In this situation, the length of the first sequence can be determined according to the BW of the first frequency band. Within the first frequency band, the first DMRS is generated by the first sequence, when the second DMRS is generated by a cyclic shift version of the first sequence. Or the first DMRS is generated by the first sequence, and the second DMRS is generated by a cyclic shift version of the first sequence.

In some possible implementations, the method further includes: determining first cyclic shift information, where the first cyclic shift information is used to indicate a cyclic shift of the first sequence relative to a second sequence. The second sequence is used to generate the second DMRS; and, transmitting the first cyclic shift information.

In one embodiment, the first cyclic shift information could be determined based on a preset value.

In another embodiment, the first cyclic shift information could be determined based on resources of a first PUSCH or a second PUSCH, where the first PUSCH corresponds to the first DMRS and the second PUSCH corresponds to the second DMRS. For example, the first cyclic shift information is determined based on a frequency band of the first PUSCH or the second PUSCH.

For example, when the first frequency band is larger than the second frequency band, the TRP can determine the first cyclic shift information based on the BW for data transmission of the first UE. When the first frequency band is less than or equal to the second frequency band, the first cyclic shift information can be determined based on the BW for data transmission of the second UE.

In another example, when the BW used for data transmission of the first UE is larger than the BW used for data transmission of the second UE, the first cyclic shift information can be determined based on the BW for data transmission of the second UE. When the BW for data transmission of the first UE is less than the BW for data transmission of the second UE, the first cyclic shift information can be determined based on the BW for data transmission of the first UE.

For illustrative purposes, the first sequence, the first sequence length information and the first cyclic shift information are described in detail in conjunction with FIG. 9 to FIG. 15. In FIG. 9 to FIG. 15, it is supposed that UE₁ is an ISAC UE, and the DMRS band of the UE₁ overlaps with that of UE₂. Moreover, UE₁ is taken as an example of the first UE, and UE₂ could be taken as an example of the second UE. Accordingly, UE₁'s DMRS is taken as an example of the first DMRS, UE₁'s PUSCH is taken as an example of the first PUSCH, UE₂'s DMRS could be taken as an example of the second DMRS, and UE₂'s PUSCH could be taken as an example of the second PUSCH.

Let

$${M}_{SC}^{Nsequence}$$

denote a BW for the first sequence, which could indicate the length of the first sequence.

For example, a sequence r(n) of the DMRS for UE₁ can be represented by the following expression.

$$r ( n ) = {e}^{jan} {x}_{q} ( n mod {N}_{zc} ) , n = 0 , 1 , ... , {M}_{SC}^{DMRS} / {2}^{δ} - 1$$

Here,

$${x}_{q} ( m ) = {e}^{- j \frac{π qm ( m + 1 )}{{N}_{zc}}}$$

is the ZC sequence with the length N_{zc}, a denotes the cyclic shift, and

$${M}_{SC}^{DMRS}$$

denotes the scheduled DMRS BW. N_{zc} can be

$${N}_{zc} = {M}_{SC}^{Nsequence} / {2}^{δ} - 1 ,$$

or it can be the largest number such that

$${N}_{zc} < {M}_{SC}^{Nsequence} / {2}^{δ} - 1.$$

This ZC sequence could be understood as the first sequence.

$${M}_{SC}^{Nsequence}$$

can be configured directly by the network, e.g., TRP could transmit

$${M}_{SC}^{Nsequence}$$

to indicate the length of the ZC sequence used to generate UE₁'s DMRS. That is to say, the first sequence length information could include

$${M}_{SC}^{Nsequence} .$$

In some possible implementations, the first sequence information could include an indication parameter. The length of the first sequence can be determined based on the indication parameter and the BW of the first DMRS.

In one embodiment, when the indication parameter takes a first value, e.g., ζ=1, or when the BW of the first DMRS is equal to the BW for data transmission of the first UE,

$${M}_{SC}^{Nsequence}$$

can be equal to the BW of the first DMRS.

In another embodiment, when the indication parameter takes a second value, e.g., ζ=0,

$${M}_{SC}^{Nsequence}$$

can be determined according to the BW of the first DMRS and the BW for data transmission of the first UE. The first value can be any other value, such as 0, 2, etc. The second value could be any other value different from the first value.

For example, in order the reduce the configuration overhead,

$${M}_{SC}^{Nsequence}$$

can be found using the equation below.

$${M}_{SC}^{Nsequence} = \{ \begin{matrix}{M}_{SC}^{DMRS} & if ς = 1 or {M}_{SC}^{DMRS} = {M}_{SC}^{PUSCH} \\ {M}_{SC}^{DMRS} - {M}_{SC}^{PUSCH} & if ς = 0 and {M}_{SC}^{DMRS} > {M}_{SC}^{PUSCH}\end{matrix}$$

Here, ζ is the indication parameter. If the UE does not receive ζ and

$${M}_{SC}^{DMRS} > {M}_{SC}^{PUSCH} ,$$

the default

$${M}_{SC}^{Nsequence}$$

could be

$${M}_{SC}^{PUSCH} .$$

For illustrative purposes, the following cases may be involved.

Case 1: If UE₂ is a communication-only UE, and scheduled data BW of UE₁ is less than scheduled data BW of UE₂, i.e.,

$${M}_{SC}^{{PUSCH}_{1}} < {M}_{SC}^{{PUSCH}_{2}} ,$$

UE₁ shall be assigned a CS with a CS extension version of

$${M}_{SC}^{Nsequence} = {M}_{SC}^{DMRS 1} - {M}_{SC}^{{PUSCH}_{1}}$$

to cover its whole extended band, where

$${M}_{SC}^{DMRS 1} = {M}_{SC}^{{PUSCH}_{1}} + {M}_{SC}^{{PUSCH}_{2}} .$$

The value of CS, a₁, is a function of

$${M}_{SC}^{{PUSCH}_{1}} ,$$

which will be configured to the UE. Let L₁ denote the number of resource elements (REs) for UE₁ data transmission. Then.

$${α}_{1} = 2 π ( 1 - \frac{1}{{L}_{1}} ) .$$

Case 1 is illustrated in FIG. 9. As shown in FIG. 9, the solid line represents a time-frequency relationship of the ZC sequence corresponding to the DMRS of UE₂, and the dashed lines represent a time-frequency relationship of the CS ZC sequence corresponding to the DMRS of UE₁. For UE₂, the data and the DMRS share the same BW, which is equal to

$${M}_{SC}^{Nsequence} .$$

The ZC sequence used to generate the UE₁'s DMRS is a cyclic shift version of the ZC sequence used to generate the UE₂'s DMRS, and a value of CS, a₁, is used to generate the DMRS sequence of UE₁. The ZC sequence used to generate the UE₁'s DMRS is orthogonal to the ZC sequence used to generate the UE₂'s DMRS, which is reflected in FIG. 9 as the dashed lines and solid line are parallel to each other. The TRP could transmit the first cyclic shift information to indicate a₁.

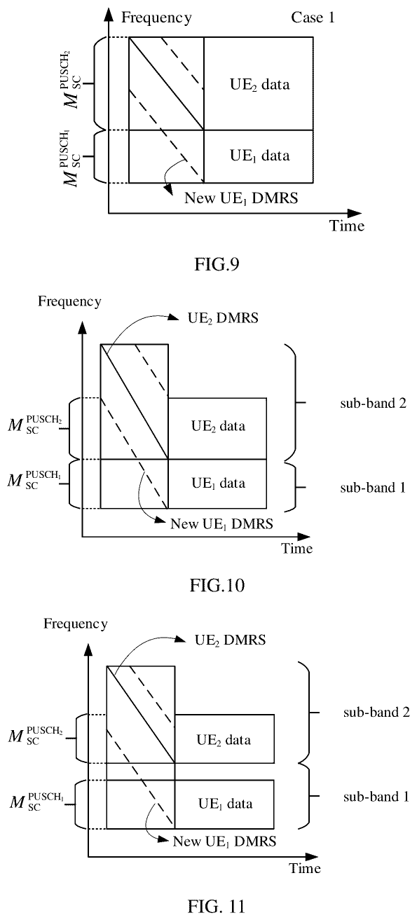

The following illustrates possible variations of case 1 in conjunction with FIG. 10 and FIG. 11. It is noted that there may be other variations of case 1, and the variations of case 1 are not limited to FIG. 0.10 and FIG. 11.

FIG. 10 is a deformation or extension of case 1. As shown in FIG. 10, the scheduled data band of UE₁ and the scheduled data band of UE₂ are adjacent to each other. For UE₂, the BW of the DMRS is larger than the BW of the data transmission, i.e.,

$${M}_{SC}^{DMRS 2} > {M}_{SC}^{{PUSCH}_{2}} .$$

A frequency band of UE₁'s DMRS includes sub-band 1 and sub-band 2, i.e.,

$${M}_{SC}^{DMRS 1} = {M}_{SC}^{subband 1} + {M}_{SC}^{subband 2} .$$

The sub-band 1 is a frequency band occupied by UE₁'s DMRS only, within the time domain of UE₁'s DMRS. For UE₁, the scheduled data BW is equal to the BW of sub-band 1, i.e.,

$${M}_{SC}^{subband 1} = {M}_{SC}^{{PUSCH}_{1}} .$$

The sub-band 2 is a frequency band occupied by UE₂'s DMRS, i.e.,

$${M}_{SC}^{subband 2} = {M}_{SC}^{DMRS 2} .$$

FIG. 11 is another deformation or extension of case 1. As shown in FIG. 11, the scheduled data band of UE₁ and the scheduled data band of UE₂ are not adjacent to each other. Unlike in FIG. 10, the BW of sub-band 1 is larger than the scheduled data BW of UE₁, i.e.,

$${M}_{SC}^{subband 1} > {M}_{SC}^{{PUSCH}_{1}} .$$

As shown in FIG. 10 and FIG. 11, the sub-band 2 could be taken as an example of the first frequency band, and the sub-band 1 could be taken as an example of the second frequency band. For the scenario shown in FIG. 10 or FIG. 11, when UE₂ is a communication-only UE and the BW of sub-band 2 is larger than the BW of sub-band 1, UE₁ shall be assigned a CS with a CS extension version of

$${M}_{SC}^{Nsequence} = {M}_{SC}^{DMRS 1} - {M}_{SC}^{subband 1}$$

to cover its whole extended band, and a value of CS, α₁, which is used to generate the DMRS sequence of UE₁, is a function of

$${M}_{SC}^{{PUSCH}_{1}} .$$

The ZC sequence used to generate the UE1's DMRS is a cyclic shift version of the ZC sequence used to generate the UE2's DMRS. In FIG. 10 and FIG. 11, the dashed line and the solid line are parallel to each other, which represents that the ZC sequence used to generate the UE₁'s DMRS is orthogonal to the ZC sequence used to generate the UE₂'s DMRS.

Case 2: If UE₂ only performs communications and the scheduled data BW of UE₁ is larger than that of UE₂, i.e.,

$${M}_{SC}^{{PUSCH}_{1}} > {M}_{SC}^{{PUSCH}_{2}} ,$$

UE₁ shall be assigned a cyclic repetition of

$${M}_{SC}^{Nsequence} = {M}_{SC}^{DMRS 1} - {M}_{SC}^{{PUSCH}_{1}} .$$

By a cyclic repetition, we mean repeating the ZC sequence whose length is determined based on

$${M}_{SC}^{Nsequence} ,$$

and using its circular expansion until the entire BW of

$${M}_{SC}^{DMRS 1}$$

is covered. The value of CS, α₁, is a function of

$${M}_{SC}^{{PUSCH}_{2}} ,$$

which will be configured to the UE. Let L₂ denote the number of REs for UE₂ data transmission. Then,

$${α}_{1} = 2 π ( 1 - \frac{1}{{L}_{2}} ) .$$

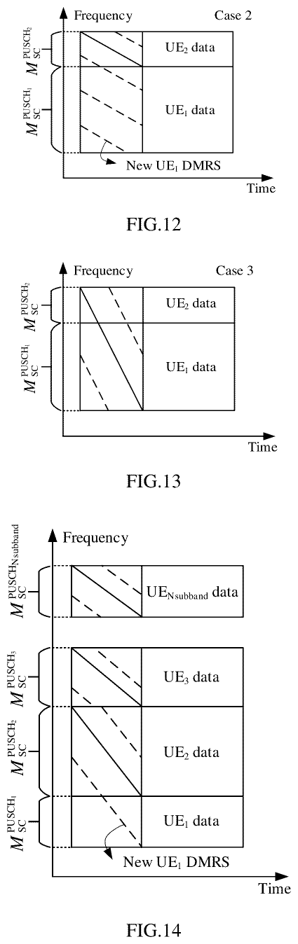

Case 2 is illustrated in FIG. 12. As shown in FIG. 12, the solid line represents a time-frequency relationship of the ZC sequence corresponding to DMRS of UE₂, and the dashed lines represent a time-frequency relationship of the CS repetition sequence corresponding to DMRS of UE₁.

Case 3: If UE₂ is performs sensing, and the scheduled data BW of UE₁ is more than the scheduled data BW of UE₂, i.e.,

$${M}_{SC}^{{PUSCH}_{1}} > {M}_{SC}^{{PUSCH}_{2}} ,$$

both UE₁ and UE₂ may extend their ZC sequence BWs to

$${M}_{SC}^{{PUSCH}_{1}} + {M}_{SC}^{{PUSCH}_{2}} , i . e . , {M}_{SC}^{Nsequence} = {M}_{SC}^{DMRS 1} = {M}_{SC}^{{PUSCH}_{1}} + {M}_{SC}^{{PUSCH}_{2}} .$$

In one embodiment, UE₁ DMRS shall be a cyclic shift of UE₂ DMRS, and the value of CS, a₁, is related to

$${M}_{SC}^{{PUSCH}_{2}} , i . e . , {α}_{1} = 2 π ( 1 - \frac{1}{{L}_{2}} ) .$$

In another embodiment, UE₂ DMRS shall be a cyclic shift of UE₁ DMRS, and the value of CS, α₂, is related to

$${M}_{SC}^{{PUSCH}_{2}} , i . e . , {α}_{2} = 2 π ( 1 - \frac{1}{{L}_{2}} ) .$$

For illustrative purposes, case 3 is illustrated in FIG. 13. As shown in FIG. 13, the solid line represents the time-frequency relationship of the ZC sequence corresponding to DMRS of UE₂ or UE₁, and correspondingly, the dashed line represents the time-frequency relationship of the CS ZC sequence corresponding to DMRS of UE₁ or UE₂.

In practice, there may be variations of case 2 and/or case 3. In a possible deformation or expansion of case 2, for UE₂, the BW of the DMRS is larger than the BW of the data transmission, i.e.,

$${M}_{SC}^{DMRS 2} > {M}_{SC}^{{PUSCH}_{2}} .$$

The frequency band of UE₁'s DMRS can be divided into sub-band 1 and sub-band 2 using the same way in FIG. 10 or FIG. 11. When UE₂ is a communication-only UE and a BW of the sub-band 2 is larger than a BW of the sub-band 1, UE₁ shall be assigned a cyclic repetition of

$${M}_{SC}^{Nsequence} = {M}_{SC}^{DMRS 1} - {M}_{SC}^{subband 1} .$$

The value of CS, α₁, is a function of

$${M}_{SC}^{{PUSCH}_{2}} .$$

In some possible implementations, there may be more than two UEs whose extended BW are not limited to two bands. For example, the DMRS band of UE₁ overlaps with that of UE₂, UE₃ and even more other UE. In such scenarios, the following can be done to ensure the orthogonality of overlapping UEs.

TRP could decide

$${M}_{SC}^{DMRS}$$

based on the sensing KPIs. For example, the more the range resolution, the higher the

$${M}_{SC}^{DMRS} ,$$

but adopting a higher

$${M}_{SC}^{DMRS}$$

can result in interfering multiple UEs with different BWs.

In one embodiment, the frequency band of the first DMRS further includes a third frequency band, the third frequency band is a frequency band configured to a third DMRS. The method may further includes determining second sequence length information based on a BW of the third frequency band, where the second sequence length information is used to indicate a length of a length of a third sequence, and the third sequence is used to generate the first DMRS in the third frequency band.

In another embodiment, TRP could further transmit second cyclic shift information, where the second cyclic shift information is used to indicate a cyclic shift of the third sequence relative to a fourth sequence, and the fourth sequence is used to generate the third DMRS.

The third UE can be an arbitrary UE, different from the first UE and the second UE. The third DMRS is configured for the third UE. The first DMRS and the third DMRS are generated based on sequences of the same type. For example, if the third sequence is a ZC sequence, the fourth sequence used to generate the third DMRS is a ZC sequence too.

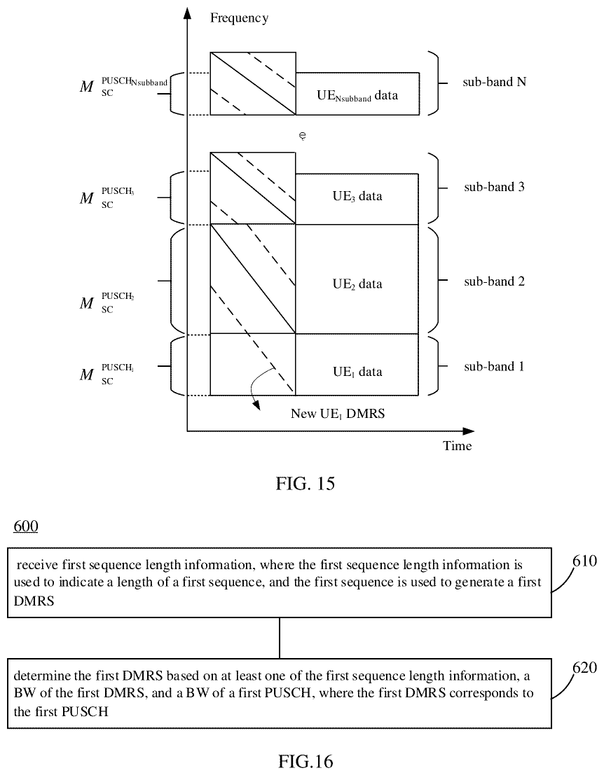

For illustrative purposes, the third UE, the third DMRS and the second sequence length information are described in detail in conjunction with FIG. 14 and FIG. 15. As mentioned above, in FIG. 14 and FIG. 15, UE₁ is taken as an example of the first UE, and UE₂ could be taken as an example of the second UE. Moreover, any one of the UE₃ up to UE_{N}_{_{subband}} could be taken as an example of the third UE, and its DMRS could be considered as the third DMRS.

In one embodiment, the

$${M}_{SC}^{Nsequence}$$

can be a vector of length N_{subband}, but not be a scalar anymore, where N_{subband} is the number of sub-bands that the ISAC UE requires to cover its

$${M}_{SC}^{DMRS}$$

and is an integer. Over each sub-band, it can generate a different ZC sequence with a different root index and cyclic shift relative to its interfering UEs. As a consequence, the root index and cyclic shift of each sub-band form the vector q and a, respectively. For example, the TRP can adjust the vector q and/or a to suppress the interference from the new ISAC UE to other UEs that have already occupied the sub-bands.

FIG. 14 shows an example of extending the DMRS BW of one UE to multiple sub-bands. As shown in FIG. 14, the solid line in each sub-band indicates the time-frequency relationship of the ZC sequence corresponding to the DMRS of the UE that has already occupied the sub-band, and the dashed line represents the time-frequency relationship of the CS ZC sequence corresponding to DMRS of UE₁. Here,

$${M}_{SC}^{{PUSCH}_{1}} , {M}_{SC}^{{PUSCH}_{2}} , {M}_{SC}^{{PUSCH}_{3}}$$

up to

$${M}_{SC}^{{N}_{subband}}$$

denote the PUSCH BW of UE₁, UE₂, UE₃ up to UE_{N}_{_{subband}}, respectively. In FIG. 14, it is supposed that the UE₃ up to UE_{N}_{_{subband}} can only perform communications. For any one of the UE₃ to UE_{N}_{_{subband}}, its data and its DMRS share the same BW.

$${M}_{SC}^{Nsequence}$$

can be a vector, for example,

$${M}_{SC}^{Nsequence} = ( {M}_{SC}^{{PUSCH}_{2}} , {M}_{SC}^{{PUSCH}_{3}} , {M}_{SC}^{{PUSCH}_{4}} , … , {M}_{SC}^{{N}_{subband}} ) .$$

TRP could transmt

$${M}_{SC}^{Nsequence}$$

to UE₁ through one or more message.

As shown in FIG. 14, over the sub-band occupied by UE₂, a ZC sequence with a root index q₁ can be generated. And a value of cyclic shift, a₁, can be determined. The q₁ and a₁ can be obtained by referring to the manners in FIG. 9 to FIG. 11.

Over the sub-band occupied by UE₃, a ZC sequence with a root index q₂ can be generated, and the length of this ZC sequence can be determined based on

$${M}_{SC}^{{PUSCH}_{3}} .$$

In this sub-band, the UE₁ shall be assigned a CS with a CS extension version to cover this whole sub-band, and the value of CS, a₂, can be a function of

$${M}_{SC}^{{PUSCH}_{3}} .$$

Over the sub-band occupied by UE_{N}_{_{subband}}, a ZC sequence with a root index q_{N}_{_{subband}}−1 can be generated, and the length of this ZC sequence can be determined based on

$${M}_{SC}^{{N}_{subband}} .$$

In this sub-band, the UE₁ shall be assigned a CS with a CS extension version to cover this whole sub-band, and the value of CS, a_{N}_{_{subband}}−1, can be a function of

$${M}_{SC}^{{N}_{subband}} .$$

For example,

$${α}_{{N}_{subband} - 1} = 2 π ( 1 - \frac{1}{{L}_{{N}_{subband}}} ) ,$$

where L_{N}_{_{subband}} and denotes the number of REs for UE_{N}_{_{subband}} data transmission.

Thus, vector α=(α₁, α₂, α₃, . . . , α_{N}_{_{subband}}−1) and q=(q₁, q₂, q₃, . . . , g_{N}_{_{subband}}−1) can be determined.

In one embodiment, take UE₂ as an example of the second UE and UE₃ as an example of the third UE, the first sequence length information could include the 1-st element of

$${M}_{SC}^{Nsequence} , i . e . , {M}_{SC}^{{PUSCH}_{2}}$$

and the second sequence length information could include a 2-nd element of

$${M}_{SC}^{Nsequence} , i . e . , {M}_{SC}^{{PUSCH}_{3}} .$$

The first sequence length information and the second sequence length information could be carried on the same message. And in this situation, the first cyclic shift information could include the 1-st element of α, i.e., α₁, and the second cyclic shift information could include the 2-nd element of a, i.e., α₂.

FIG. 15 is a deformation or extension of FIG. 14. Unlike in FIG. 14, for at least one of UE₂, UE₃ up to UE_{N}_{_{subband}}, its DMRS BW is larger than the BW of the data transmission. As shown in FIG. 15, the frequency band of UE₁'s DMRS can be divided into sub-band 1, sub-band 2 up to sub-band N, corresponding to the DMRS band of UE₂, UE₃ up to UE_{N}_{_{subband}}. For example, over the sub-band 3, a ZC sequence with a root index q₂ can be generated, and the length of this ZC sequence can be determined based on the BW of the sub-band 3. In the sub-band 3, the UE₁ shall be assigned a CS with a CS extension version, and the value of CS, α₂, can be a function of

$${M}_{SC}^{{PUSCH}_{3}} .$$

There may be other variation of the FIG. 14. This is not limited in this application.

In some possible implementations, the frequency band of the first DMRS is not overlapping with the frequency band of the second DMRS. In other words, the frequency band of the second DMRS is outside the frequency band of the first DMRS. In this situation, the length of the first sequence can be determined according to the BW of the first DMRS. For example, the indication parameter could take a first value, e.g., [symbol] =1,

$${M}_{SC}^{Nsequence}$$

can be equal to the BW of the first DMRS.

FIG. 16 is a schematic diagram of a method 600 for configuring DMRS of the present application. As shown in FIG. 16, the method 600 specifically includes the following steps.

Step 610: a first UE receives first sequence length information, where the first sequence length information is used to indicate a length of a first sequence, and the first sequence is used to generate a first DMRS.

The first UE could be an arbitrary ISAC UE, and the first DMRS is configured for the first UE. The first sequence could be any constant envelope sequence. For the first sequence length information, the first sequence, the first UE and the first DMRS, refer to the detailed description of method 500. Details are not described herein again.

In one embodiment, the first sequence length information could include

$${M}_{SC}^{Nsequence}$$

which can be referred to the description of method 500.

In some possible implementations, the first sequence length information includes an indication parameter, and determining the first DMRS based on at least one of the first sequence length information, a BW of the first DMRS and a BW of a first PUSCH, includes: when the indication parameter takes a first value or when the BW of the first DMRS is equal to the BW of the first PUSCH, determining the length of the first sequence based on the BW of the first DMRS; or when the indication parameter takes a second value, determining the length of the first sequence based on a difference of the BW of the first DMRS and the BW of the first PUSCH; and determining the first sequence and the first DMRS based on the length of the first sequence.

For example, the first sequence length information could include the indication parameter [symbol] , which can be referred to the description of method 500.

Step 620: the first UE determines the first DMRS based on at least one of the first sequence length information, a BW of the first DMRS, and a BW of a first PUSCH, where the first DMRS corresponds the first PUSCH.

In some possible implementations, determining the first DMRS based on at least one of the first sequence length information, a BW of the first DMRS and a BW of a first PUSCH, comprises of determining the first sequence based on the first sequence length information; and generating the first DMRS based on the first sequence.

In one embodiment, a frequency band of the first DMRS includes a first frequency band, the first frequency band is a frequency band of a second DMRS, the first sequence length information is determined based on the first frequency band. Generating the first DMRS based on the first sequence, comprises of generating the first DMRS in the first frequency band based on the first sequence.

In another embodiment, when the frequency band of the second DMRS is within the frequency band of the first DMRS and the BW of the second DMRS is less than the BW of the first DMRS, the frequency band of the first DMRS could further include a second frequency band, and the second frequency band is occupied by the first DMRS only. Generating the first DMRS based on the first sequence, comprises of generating the first DMRS in the second frequency band based on the first sequence. For example, the first DMRS within the first frequency band and the second frequency band could be generated by an extension version of the first sequence.

For example, as shown in FIG. 9 to FIG. 15, UE₁ is taken as an example of the first UE, and UE₂ could be taken as an example of the second UE. Accordingly, UE₁'s DMRS is taken as an example of the first DMRS, UE₁'s PUSCH is taken as an example of the first PUSCH, UE₂'s DMRS could be taken as an example of the second DMRS, and UE₂'s PUSCH could be taken as an example of the second PUSCH. For the first frequency band, the second frequency band and how to generate the first DMRS, refer to the detailed description of method 500.

In some possible implementations, the method 600 further includes receiving first cyclic shift information, where the first cyclic shift information is used to indicate a cyclic shift of the first sequence. Determining the first sequence based on the first sequence length information, includes determining the first sequence based on the first sequence length information and the first cyclic shift information.

For example, the first cyclic shift information is used to indicate a cyclic shift of the first sequence relative to the second sequence used to generate the second DMRS.

In another example, the first cyclic shift information is determined according to the resources of the first PUSCH or a second PUSCH which corresponds to the second DMRS, and can be referred to the method 500.

In one embodiment, a frequency band of the first DMRS further includes a third frequency band, the third frequency band is a frequency band of a third DMRS. The method may further include receiving second sequence length information, where the second sequence length information is used to indicate a length of a third sequence; and determining the third sequence based on the second sequence length information, where the third sequence is used to generate the first DMRS in the third frequency band.

In some possible implementations, the method further includes receiving second cyclic shift information, where the second cyclic shift information is used to indicate a cyclic shift of the third sequence. Determining the third sequence based on the second sequence length information, comprises of determining the third sequence based on the second sequence length information and the second cyclic shift information.

For example, the third UE can be an arbitrary UE, different from the first UE and the second UE. The third DMRS is configured for the third UE. For the third UE, the third DMRS, the third sequence, the fourth sequence and the second cyclic shift information, refer to the detailed description of method 500. Details are not described herein again.

In some possible implementations, the method further includes: receiving expansion information, where the expansion information is used to indicate an expansion of the frequency band of the first DMRS relative to a frequency band of a first PUSCH; and determining the BW of the PUSCH based on the expansion information.

In some possible implementations, the method further includes: receiving frequency hopping information, where the frequency hopping information indicates a frequency hopping manner of the frequency band of the first PUSCH within the frequency band of the first DMRS; and determining the first PUSCH.

In some possible implementations, the method further includes transmitting first indication information, where the first indication information indicates a communication mode of UE, and the communication mode includes a communication-only device or an ISAC device.

In some possible implementations, first sequence length information is carried on RRC or DCI.

The configuration information of the DMRS includes one or more of the following: first sequence length information, first cyclic shift information, second cyclic shift information, expansion information, frequency hopping information, and second sequence length information. For the description of these information, it can be referred to the description of method 500 and method 600.

In one embodiment, the configuration information can be performed semi-statically through RRC, or dynamically through DCI.

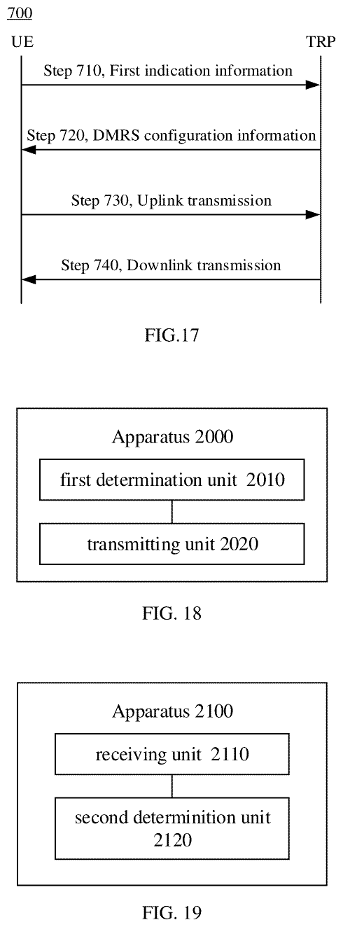

FIG. 17 is a schematic diagram of signal diagram of the present application. As shown in FIG. 17, configuration of DMRS may include some or all of the following steps.

Step 710, UE transmits first indication information, and correspondingly, a TRP receives the indication information.

For example, it can be determined whether this UE is a communication-only device or an ISAC device according to the first indication information.

Step 720, the TRP transmits configuration information of DMRS. Correspondingly, UE receives the configuration information of DMRS.

For example, the configuration information can include the DMRS BW, the ZC sequence BW, and/or an indication parameter.

For the uplink transmission, the method may further include step 730; or, for downlink transmission, the method may further include step 740.

Step 730, perform uplink transmission.

Step 740, perform downlink transmission.

Combined with the foregoing method embodiment, the present application further provides related devices, and the devices may be located in a controller or a controlee. The related devices may perform the steps of the foregoing method embodiment.

FIG. 18 is a schematic block diagram of an apparatus 2000 for configuring DMRS according to an embodiment of this application. The apparatus 2000 can perform the steps executed by the TRP in foregoing embodiments.

As shown in FIG. 18, the apparatus 2000 includes: a first determination unit 2010, configured to determine the first sequence length information based on a BW of the first frequency band; transmitting unit 2020, configured to transmit the first sequence length information.

In a possible implementation, the first DMRS in the first frequency band is generated according to the first sequence.

In a possible implementation, the frequency band of the first DMRS could further include the second frequency band, and the first DMRS in the second frequency band is generated based on the first sequence.

In a possible implementation, the first determination unit 2010 is further configured to determine the first cyclic shift information. The transmitting unit 2020 is further configured to transmit the first cyclic shift information.

In a possible implementation, the first DMRS corresponds to the first PUSCH, and the second DMRS corresponds to the second PUSCH. The first determination unit 2010 is configured to determine the first cyclic shift information based on the BW of the first PUSCH or the BW of the second PUSCH.

In a possible implementation, the frequency band of the first DMRS could further include the third frequency band. The first determination unit 2010 is further configured to determine the second sequence length information based on the BW of the third frequency band. The transmitting unit 2020 is further configured to transmit the second sequence length information.

In a possible implementation, the first determination unit 2010 is further configured to determine the second cyclic shift information. The transmitting unit 2020 is further configured to transmit the second cyclic shift information.

In a possible implementation, the first sequence length information could include an indication parameter, where the indication parameter is used to determine the length of the first sequence with a BW of the first DMRS.

In a possible implementation, when the indication parameter takes a first value or when the BW of the first DMRS is equal to the BW of the first PUSCH, the length of the first sequence is determined based on the BW of the first DMRS; or, when the indication parameter takes a second value, the length of the first sequence is determined according to a difference of the BW of the first DMRS and a BW of the first PUSCH.

In a possible implementation, the first determination unit 2010 could be further configured to determine the expansion information. The transmitting unit 2020 is further configured to transmit the expansion information.

In a possible implementation, the first determination unit 2010 could be further configured to determine the frequency hopping information. The transmitting unit 2020 is further configured to transmit the frequency hopping information.

In a possible implementation, the first determination unit 2010 could be further configured to obtain the first indication information and determine that the first UE is the ISAC device based on the first indication information.

In a possible implementation, the first sequence length information is carried on an RRC channel or a DCI channel.

For the first sequence, the second sequence, the third sequence, the first sequence length information, the second sequence length information, the first frequency band, the second frequency band, the third frequency band, the first cyclic shift information, the second cyclic shift information, the indication parameter, the expansion information, the frequency hopping information, and the first indication information, refer to the detailed description of method 500. Details are not described herein again.

FIG. 19 is a schematic block diagram of an apparatus 2100 for configuring DMRS according to an embodiment of this application. The apparatus 2100 can perform the steps executed by the TRP in foregoing embodiments.

As shown in FIG. 19, the apparatus 2100 includes: a receiving unit 2110, configured to receive the first sequence length information; a second determination unit 2120, configured to determine the first DMRS based on at least one of the first sequence length information, the BW of the first DMRS and the BW of the first PUSCH.

In a possible implementation, the first sequence length information includes the indication parameter. And the second determination unit 2120 is configured to: determine the length of the first sequence based on the BW of the first DMRS, when the indication parameter takes a first value or when the BW of the first DMRS is equal to the BW of the first PUSCH; or determine the length of the first sequence based on a difference of the BW of the first DMRS and the BW of a first PUSCH, when the indication parameter takes a second value; and determine the first sequence and the first DMRS based on the length of the first sequence.

In a possible implementation, the second determination unit 2120 is configured to: determine the first sequence based on the first sequence length information; and generate the first DMRS based on the first sequence.

In a possible implementation, the frequency band of the first DMRS includes the first frequency band. The second determination unit 2120 is configured to generate the first DMRS in the first frequency band based on the first sequence.

In a possible implementation, the frequency band of the first DMRS could further include the second frequency band. The second determination unit 2120 is configured to generate the first DMRS in the second frequency band based on the first sequence.

In a possible implementation, the receiving unit 2110 could be further configured to receive the first cyclic shift information. The second determination unit 2120 is configured to determine the first sequence based on the first sequence length information and the first cyclic shift information.

In a possible implementation, the frequency band of the first DMRS could further include the third frequency band, and the third frequency band is a frequency band of the third DMRS. The receiving unit 2110 could be further configured to receive the second sequence length information. The second determination unit 2120 is further configured to determine the third sequence based on the second sequence length information, where the third sequence is used to generate the first DMRS in the third frequency band.

In a possible implementation, the receiving unit 2110 could be further configured to receive second cyclic shift information, where the second cyclic shift information is used to indicate a cyclic shift of the third sequence. The second determination unit 2120 is configured to determine the third sequence based on the second sequence length information and the second cyclic shift information.

In a possible implementation, the receiving unit 2110 could be further configured to receive the expansion information. The second determination unit 2120 is configured to determine the BW of the PUSCH based on the expansion information.

In a possible implementation, the receiving unit 2110 could be further configured to receive the frequency hopping information. The second determination unit 2120 is configured to determine the first PUSCH.

In a possible implementation, the apparatus 2100 further includes a transmitting unit 2130, configured to transmit the first indication information to indicate the communication mode of the first UE.

In a possible implementation, the first sequence length information is carried on an RRC channel or a DCI channel.

For the description of the first sequence, the second sequence, the third sequence, the first sequence length information, the second sequence length information, the first frequency band, the second frequency band, the third frequency band, the first cyclic shift information, the second cyclic shift information, the indication parameter, the expansion information, the frequency hopping information, and the first indication information, reference is made to the foregoing embodiments. Details are not described herein again.

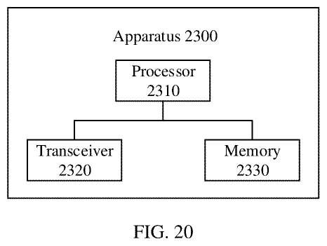

As shown in FIG. 20, an apparatus 2300 for configuring DMRS may include a processor 2310, a transceiver 2320, and a memory 2330. The transceiver 2320 may be configured to receive a query. The memory 2330 may be configured to store code, instructions, and the like executed by the processor 2310.

Besides, the memory 2330 may be further configured to store data used to configure DMRS, such as the sensing key performances indicators of the first UE, the frequency band of the first DMRS.

The memory 2330 may include a random memory, a flash memory, a read-only memory, a programmable read-only memory, a non-volatile memory, a register, or the like. The processor 2310 may be a central processing unit (CPU).

For other functions and operations of the communication apparatus 2300, refer to processes of the method embodiments in FIG. 5 to FIG. 17, which are not described again herein to avoid repetition.

An embodiment of the present application further provides a communication system. The communication system includes apparatus 2000 and apparatus 2100, or includes apparatus 2300.

An embodiment of the present application further provides a computer storage medium, and the computer storage medium may store a program instruction for performing the steps in the foregoing methods.

Optionally, the storage medium may be specifically the memory 2330.

An embodiment of the present application further provides a computer program product. The computer program product includes computer program code. When the computer program code runs on a computer, the computer is enabled to perform the steps in the foregoing methods.

Optionally, all or a part of computer program code can be stored in on a first storage medium. The first storage medium can be packaged together with the processor or separately with the processor.

An embodiment of the present application further provides a chip system, where the chip system includes an input/output interface, at least one processor, at least one memory, and a bus. The at least one memory is configured to store instructions, and the at least one processor is configured to invoke the instructions of the at least one memory to perform operations in the methods in the foregoing embodiments.

In the embodiments of the present application, “at least one” means one or more, and “a plurality of” means two or more. The term “and/or” describes an association relationship between associated objects and represents that three relationships may exist. For example, A and/or B may represent the following three cases: only A exists, both A and B exist, and only B exists, where A and B may be singular or plural. The character “/” generally indicates an “or” relationship between the associated objects. “At least one of the following” and a similar expression thereof refer to any combination of these items, including any combination of one item or a plurality of items. For example, at least one of a, b, and c may indicate: a, b, c, a and b, a and c, b and c, or a, b, and c, where a, b, and c may be singular or plural.

A person of ordinary skill in the art may understand that all or some of the processes of the methods in the embodiments may be implemented by a computer program instructing related hardware. The program may be stored in a computer-readable storage medium. When the program runs, the processes of the methods in the embodiments are performed. The foregoing storage medium may include: a magnetic disk, an optical disc, a read-only memory (ROM), or a random-access memory (RAM).

In the several embodiments provided in this application, it should be understood that the disclosed system and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method comprising:
determining first sequence length information based on a bandwidth (BW) of a first frequency band, wherein the first sequence length information indicates a length of a first sequence used to generate a first demodulation reference signal (DMRS), the first frequency band is of a second DMRS, and a frequency band of the first DMRS comprises the first frequency band; and
transmitting the first sequence length information.

2. The method of claim 1, wherein the first DMRS in the first frequency band is generated according to the first sequence.

3. The method of claim 2, wherein the frequency band of the first DMRS further comprises a second frequency band, the second frequency band is occupied by the first DMRS only, and the first DMRS in the second frequency band is generated according to the first sequence.

4. The method of claim 1, further comprising:
determining first cyclic shift information, wherein the first cyclic shift information indicates a cyclic shift of the first sequence relative to a second sequence, and the second sequence is used to generate the second DMRS; and
transmitting the first cyclic shift information.

5. A method comprising:
receiving first sequence length information, wherein the first sequence length information indicates a length of a first sequence, and the first sequence is used to generate a first demodulation reference signal (DMRS); and
determining the first DMRS based on at least one of the first sequence length information, a bandwidth (BW) of the first DMRS, or a BW of a first PUSCH, wherein the first DMRS corresponds to the first PUSCH.

6. The method of claim 5, wherein the first sequence length information comprises an indication parameter, and determining the first DMRS based on at least one of the first sequence length information, the BW of the first DMRS, or the BW of the first PUSCH, comprises:
when the indication parameter is a first value or when the BW of the first DMRS is equal to the BW of the first PUSCH, determining the length of the first sequence based on the BW of the first DMRS; or
when the indication parameter is a second value different from the first value, determining the length of the first sequence based on a difference of the BW of the first DMRS and the BW of a first PUSCH; and
determining the first sequence and the first DMRS based on the length of the first sequence.

7. The method of claim 5, wherein determining the first DMRS based on at least one of the first sequence length information, the BW of the first DMRS, or the BW of the first PUSCH, comprises:
determining the first sequence based on the first sequence length information; and
generating the first DMRS based on the first sequence.

8. The method of claim 7, wherein a frequency band of the first DMRS comprises a first frequency band, the first frequency band is of a second DMRS, the first sequence length information is determined based on the first frequency band, and generating the first DMRS based on the first sequence comprises:
generating the first DMRS in the first frequency band based on the first sequence.

9. The method of claim 8, wherein the frequency band of the first DMRS further comprises a second frequency band, the second frequency band is occupied by the first DMRS only, and generating the first DMRS based on the first sequence comprises:
generating the first DMRS based on the first sequence in the second frequency band.

10. The method of claim 7, further comprising:
receiving first cyclic shift information, wherein the first cyclic shift information indicates a cyclic shift of the first sequence; and
wherein determining the first sequence based on the first sequence length information comprises:
determining the first sequence based on the first sequence length information and the first cyclic shift information.

11. The method of claim 5, further comprising:
receiving expansion information, wherein the expansion information indicates an expansion of the frequency band of the first DMRS relative to a frequency band of a first PUSCH; and
determining the BW of the PUSCH based on the expansion information.

12. The method of claim 5, further comprising:
receiving frequency hopping information, wherein the frequency hopping information indicates a frequency hopping manner of the frequency band of the first PUSCH within the frequency band of the first DMRS; and
determining the first PUSCH based on the frequency hopping information.

13. An apparatus comprising:
at least one processor; and
memory coupled to the at least one processor, the memory storing instructions that, when executed by the at least one processor, cause the apparatus to perform operations including:
receiving first sequence length information, wherein the first sequence length information indicates a length of a first sequence, and the first sequence is used to generate a first demodulation reference signal (DMRS); and
determining the first DMRS based on at least one of the first sequence length information, a bandwidth (BW) of the first DMRS, or a BW of a first PUSCH, wherein the first DMRS corresponds to the first PUSCH.

14. The apparatus of claim 13, wherein the first sequence length information comprises an indication parameter, and determining the first DMRS based on at least one of the first sequence length information, the BW of the first DMRS, or the BW of the first PUSCH comprises:
when the indication parameter is a first value or when the BW of the first DMRS is equal to the BW of the first PUSCH, determining the length of the first sequence based on the BW of the first DMRS; or
when the indication parameter is a second value different from the first value, determining the length of the first sequence based on a difference of the BW of the first DMRS and the BW of a first PUSCH; and
determining the first sequence and the first DMRS based on the length of the first sequence.

15. The apparatus of claim 13, wherein determining the first DMRS based on at least one of the first sequence length information, the BW of the first DMRS, or the BW of the first PUSCH, comprises:
determining the first sequence based on the first sequence length information; and
generating the first DMRS based on the first sequence.

16. The apparatus of claim 15, wherein a frequency band of the first DMRS comprises a first frequency band, the first frequency band is of a second DMRS, the first sequence length information is determined based on the first frequency band, and generating the first DMRS based on the first sequence comprises:
generating the first DMRS in the first frequency band based on the first sequence.

17. The apparatus of claim 16, wherein the frequency band of the first DMRS further comprises a second frequency band, the second frequency band is occupied by the first DMRS only, and generating the first DMRS based on the first sequence, comprises:
generating the first DMRS based on the first sequence in the second frequency band.

18. The apparatus of claim 15, wherein the instructions cause the apparatus to perform further operations including:
receiving first cyclic shift information, wherein the first cyclic shift information indicates a cyclic shift of the first sequence; and
wherein determining the first sequence based on the first sequence length information comprises:
determining the first sequence based on the first sequence length information and the first cyclic shift information.

19. The apparatus of claim 13, wherein the instructions cause the apparatus to perform further operations including:
receiving expansion information, wherein the expansion information indicates an expansion of the frequency band of the first DMRS relative to a frequency band of a first PUSCH; and
determining the BW of the PUSCH based on the expansion information.

20. The apparatus of claim 13, wherein the instructions cause the apparatus to perform further operations including:
receiving frequency hopping information, wherein the frequency hopping information indicates a frequency hopping manner of the frequency band of the first PUSCH within the frequency band of the first DMRS; and
determining the first PUSCH based on the frequency hopping information.
